(19) United States
(12) Patent Application Publication
(10) Pub. No.: US 2024/0370554 A1
(43) Pub. Date: Nov. 7, 2024

(54) SYSTEMS, METHODS, AND APPARATUSES FOR THREAT INDEXING AND IMPLEMENTING AI TO DETECT MALFEASANT USER ACTIVITY IN AN ELECTRONIC ENVIRONMENT

(71) Applicant: BANK OF AMERICA CORPORATION, Charlotte, NC (US)

(72) Inventors: Elaina A. Williams, Davidson, NC (US); Anuja Mishra, Charlotte, NC (US); Tomas M. Castrejon, III, Fort Mill, SC (US); Mark Alan Odiorne, Waxhaw, NC (US)

(73) Assignee: BANK OF AMERICA CORPORATION, Charlotte, NC (US)

(21) Appl. No.: 18/143,906

(22) Filed: May 5, 2023

(51) Int. Cl. G06F 21/55; G06F 21/57

(52) U.S. Cl. CPC G06F 21/554; G06F 21/552; G06F 21/577

(57) ABSTRACT

Systems, computer program products, and methods are described herein for threat indexing and implementing artificial intelligence (AI) to detect malfeasant user activity in an electronic network. The present invention is configured to identify a resource transmission request associated with a user account; collect resource account data of the user account; collect resource transmission request data associated with the resource transmission request; apply a malfeasant identification artificial intelligence (AI) engine to the resource account data and the resource transmission request data; and determine, by the malfeasant identification AI engine, a malfeasant attribute of the resource transmission request, wherein the malfeasant attribute comprises at least one of a positive malfeasant attribute or a negative malfeasant attribute.

### FIELD OF THE INVENTION

The present invention embraces a system for threat indexing and implementing AI to detect malfeasant user activity in an electronic network.

### BACKGROUND

Malfeasant user activity—such as user activities committed over electronic networks and other such remote user activities—are now more difficult than ever to pick out as potentially malfeasant. Thus, there exists a need for a system to accurately, efficiently, and securely determine when potential malfeasant user activities are occurring, especially where limited data may be available and/or where the user is committing these user activities remote from entities that would complete their requests.

Applicant has identified a number of deficiencies and problems associated with threat indexing and implementing AI to detect malfeasant user activity in an electronic network. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for threat indexing and implementing artificial intelligence (AI) to detect malfeasant user activity is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to perform the following operations: identify a resource transmission request associated with a user account; collect resource account data of the user account; collect resource transmission request data associated with the resource transmission request; apply a malfeasant identification artificial intelligence (AI) engine to the resource account data and the resource transmission request data; and generate, by the malfeasant identification AI engine, a malfeasant attribute of the resource transmission request, wherein the malfeasant attribute comprises at least one of a positive malfeasant attribute or a negative malfeasant attribute.

In some embodiments, the computer-readable code is configured to cause the at least one processing device to perform the following operations: identify at least one user account attribute associated with the user account; identify at least one similar user account based on the at least one similar user account comprising the at least one user account attribute; collect similar user account data associated with the at least one similar user account; apply the malfeasant identification AI engine to the similar user account data; and train, based on the application of the malfeasant identification AI engine to the similar user account data, the malfeasant identification AI engine. In some embodiments, the similar user account data is associated with a negative malfeasant attribute. In some embodiments, the user account attribute comprises a high resource attribute.

In some embodiments, the computer-readable code is configured to cause the at least one processing device to perform the following operations: collect at least one previous resource transmission request data, wherein the at least one previous resource transmission request data comprises the positive malfeasant attribute; apply the malfeasant identification AI engine to the at least one previous resource transmission request data; and train, based on the application of the malfeasant identification AI engine to the at least one previous resource transmission request data, the malfeasant identification AI engine. In some embodiments, the computer-readable code is configured to cause the at least one processing device to perform the following operation generate, based on the collection of the at least one previous resource transmission request data, a threat index, wherein the threat index comprises the at least one previous resource transmission request data, at least one previous user account identifier associated with the at least one previous resource transmission request data, and the positive malfeasant attribute. In some embodiments, the at least one previous resource transmission request data is associated with a plurality of user accounts.

In some embodiments, the computer-readable code is configured to cause the at least one processing device to perform the following operations: generate a malfeasant alert based on the malfeasant attribute, wherein, in an instance where the malfeasant attribute comprises a positive malfeasant attribute, generate a positive malfeasant alert, or wherein, in an instance where the malfeasant attribute comprises a negative malfeasant attribute, generate a negative malfeasant alert. In some embodiments, the computer-readable code is configured to cause the at least one processing device to perform the following operations: generate a positive malfeasant attribute interface component based on the positive malfeasant attribute, wherein the positive malfeasant attribute interface component comprises the resource transmission request data and positive malfeasant attribute; transmit the positive malfeasant attribute interface component to a user device, wherein the user device is associated with an entity of the user account; dynamically configure the graphical user interface of the user device associated with the entity with the positive malfeasant attribute interface component. In some embodiments, the computer-readable code is configured to cause the at least one processing device to perform the following operations: receive, from the user device associated with the entity of the user account, a malfeasant attribute indicator, wherein the malfeasant attribute indicator comprises a positive malfeasant indicator or a negative malfeasant indicator; apply the malfeasant identification AI engine to the malfeasant attribute indicator; and train, based on the application of the malfeasant identification AI engine to the malfeasant attribute indicator, the malfeasant identification AI engine.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for threat indexing and implementing AI to detect malfeasant user activity in an electronic network, in accordance with an embodiment of the invention;

FIG. 2 illustrates technical components of an exemplary artificial intelligence subsystem, in accordance with an embodiment of the invention;

FIG. 3 illustrates a process flow for threat indexing and implementing AI to detect malfeasant user activity in an electronic network, in accordance with an embodiment of the invention;

FIG. 4 illustrates a process flow for training the malfeasant identification AI engine using similar user account data, in accordance with an embodiment of the invention;

FIG. 5 illustrates a process flow for generating a threat index, in accordance with an embodiment of the invention;

FIG. 6 illustrates a process flow for dynamically configuring a graphical user interface (GUI) of a user device with the positive malfeasant attribute interface component, in accordance with an embodiment of the invention; and

FIG. 7 illustrates a process flow for training the malfeasant identification AI engine using a malfeasant attribute indicator, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” or “graphical user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software, such as an AI engine. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository-a storage location where one or more resources are organized, stored and retrieved electronically using a computing device.

As used herein, a “resource transfer,” “resource distribution,” “resource transmission,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As discussed briefly above, malfeasant user activity—such as user activities committed over electronic networks and other such remote user activities—are now more difficult than ever to pick out as potentially malfeasant. For instance, and where such user activities comprise a request for resource transmissions and the identity or promises made for these resources cannot be readily verified by an entity meant to fulfill the resource transmission, there exists a need for a system that can accurately and quickly make such determinations based on the known data of the user, known data of other users in similar situations, and/or other data of previous requests. Thus, there exists a need for a system to accurately, efficiently, and securely determine when potential malfeasant user activities are occurring, especially where limited data may be available and/or where the user is committing these user activities remote from entities or organizations that would fulfill/perform/complete their requests.

For instance, and where a user requesting a resource transmission (such as a resource advancement like a resource limit request or loan request, or a resource transfer to their account from another user's account or an entity's account) commits a falsehood and states that they have resources that they actually do not and/or have an ability that they actually do not, the entity performing the resource transmission may need to separately verify the user's capabilities quickly and accurately. The problem is even more exacerbated where the user has only recently been involved with the entity and/or has only recently set up a user account with the entity. In these instances, the entity and its data may not accurately portray the specific user's capabilities as there are no previous interactions to base their verification on the user or their resources.

Accordingly, the present disclosure provides a system, computer program product and computer implemented method which may all comprise the capabilities to identify a resource transmission request associated with a user account; collect resource account data of the user account (e.g., what kind of resources the user may have, what resource rating the user may have, what kind of attributes the user account may have, and/or the like); collect resource transmission request data associated with the resource transmission request (e.g., what is the user requesting); apply a malfeasant identification artificial intelligence (AI) engine to the resource account data and the resource transmission request data (which may be trained a variety of ways, and which are described in further detail below); and generate, by the malfeasant identification AI engine, a malfeasant attribute (e.g., whether the resource transmission request comprises malfeasant user activity and should be flagged to alert an entity associated with the requested resource transmission) of the resource transmission request, wherein the malfeasant attribute comprises at least one of a positive malfeasant attribute (e.g., malfeasant user activity is present) or a negative malfeasant attribute (e.g., malfeasant user activity is not present).

What is more, the present invention provides a technical solution to a technical problem. As described herein, the technical problem includes the accurate and efficient determination of malfeasant user activities, especially when the user cannot be easily or readily verified based on the data already at hand. The technical solution presented herein allows for the accurate, efficient, and secure determination of malfeasant user activities using artificial intelligence, and in some embodiments, threat indexing. In particular, the malfeasance identification system is an improvement over existing solutions to the identification and determination of malfeasant user activities, (i) with fewer steps to achieve the solution, thus reducing the amount of computing resources, such as processing resources, storage resources, network resources, and/or the like, that are being used (e.g., the malfeasant identification AI engine may be trained with a variety of datasets, whereby each dataset used to train may be reduced and/or changed based on the data available—such as the quality, breadth, and/or the like—where such a choice could be made in real-time based on the data available and the way in which the data is stored and/or organized-such as through a threat index and other forms of indexing), (ii) providing a more accurate solution to problem, thus reducing the number of resources required to remedy any errors made due to a less accurate solution (e.g., by integrating a malfeasant identification AI engine that may be trained by a variety of datasets, the malfeasance identification system allows for more accurate determinations of malfeasant user activity and more streamlined decision-making, where only some datasets may be used for training or all the datasets described herein may be used), (iii) removing manual input and waste from the implementation of the solution, thus improving speed and efficiency of the process and conserving computing resources (e.g., by only requiring manual input when necessary or for training purposes, such as for feedback to the malfeasant identification AI engine), (iv) determining an optimal amount of resources that need to be used to implement the solution, thus reducing network traffic and load on existing computing resources (e.g., through the organization of datasets/indexes used to train the malfeasant identification AI engine). Furthermore, the technical solution described herein uses a rigorous, computerized process to perform specific tasks and/or activities that were not previously performed. In specific implementations, the technical solution bypasses a series of steps previously implemented, thus further conserving computing resources.

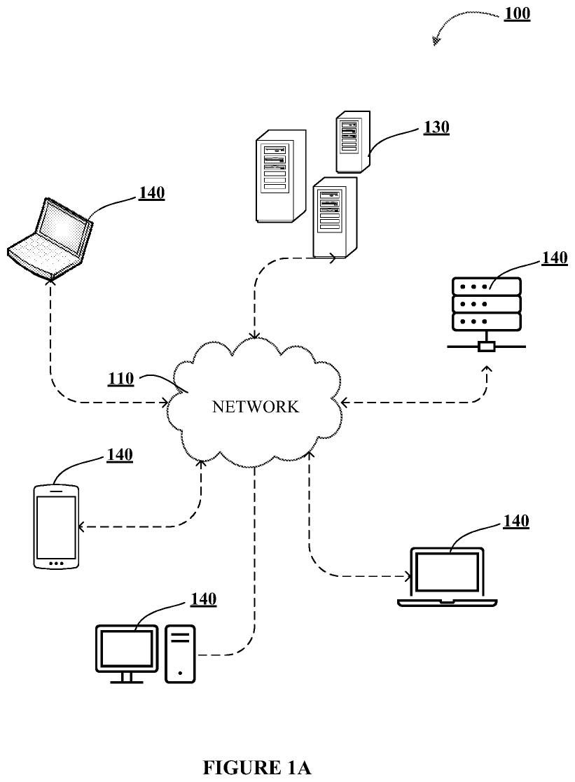

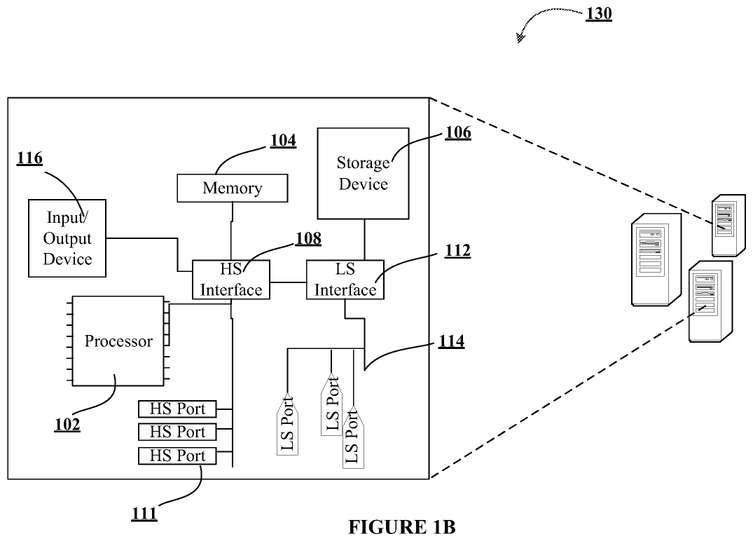

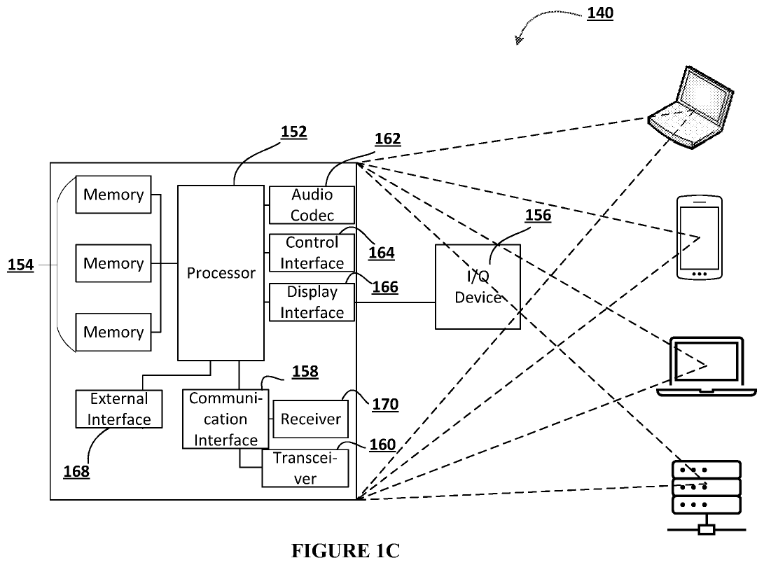

FIGS. 1A-1C illustrate technical components of an exemplary distributed computing environment for threat indexing and implementing AI to detect malfeasant user activity in an electronic network 100, in accordance with an embodiment of the invention. As shown in FIG. 1A, the distributed computing environment 100 contemplated herein may include a system 130 (i.e., a malfeasance identification system), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a Microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer—or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

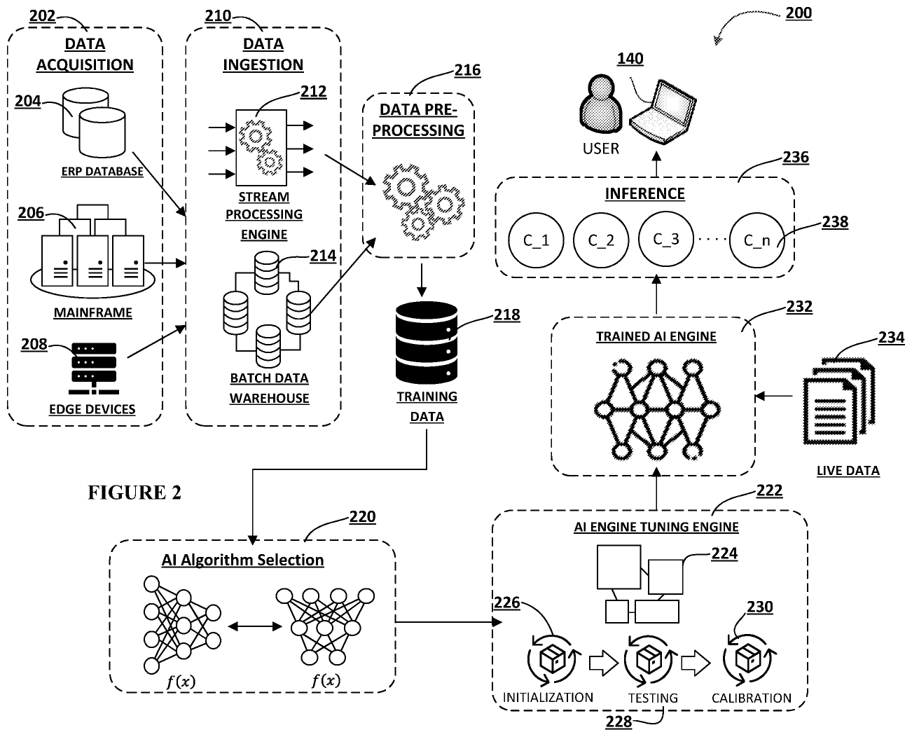

FIG. 2 illustrates an exemplary artificial intelligence (AI) subsystem architecture 200 (such as a malfeasance identification AI engine), in accordance with an embodiment of the invention. The AI subsystem 200 may include a data acquisition engine 202, data ingestion engine 210, data pre-processing engine 216, AI model tuning engine 222, and inference engine 236.

The data acquisition engine 202 may identify various internal and/or external data sources to generate, test, and/or integrate new features for training the AI engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the AI engine 224 to learn. The data pre-processing engine 216 may implement advanced integration and processing steps needed to prepare the data for artificial intelligence engine execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI engine tuning 222 may be used to train an AI engine 224 using the training data 218 to make predictions or decisions without explicitly being programmed to do so. The AI engine 224 represents what was learned by the selected AI algorithm selection 220 and represents the rules, numbers, and any other algorithm-specific data structures required for classification. Selecting the right AI engine algorithm may depend on a number of different factors, such as the problem statement and the kind of output needed, type and size of the data, the available computational time, number of features and observations in the data, and/or the like. AI engine algorithms may refer to programs (math and logic) that are configured to self-adjust and perform better as they are exposed to more data. To this extent, AI engine algorithms are capable of adjusting their own parameters, given feedback on previous performance in making prediction about a dataset.

The AI engine algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable AI engine type. Each of these types of AI engine algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the AI engine, the EI engine tuning engine 222 may repeatedly execute cycles of experimentation 226, testing 228, and tuning 230 to optimize the performance of the AI engine 220 and refine the results in preparation for deployment of those results for consumption or decision making. To this end, the AI engine tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the AI engine is the measurement used to determine which set of hyperparameters is best at identifying relationships and patterns between variables in a dataset based on the input, or training data 218. A fully trained AI engine 232 is one whose hyperparameters are tuned and model accuracy maximized.

The trained AI engine 232, similar to any other software application output, can be persisted to storage, file, memory, or application, or looped back into the processing component to be reprocessed. More often, the AI engine 232 is deployed into an existing production environment to make practical business decisions based on live data 234. To this end, the AI subsystem 200 uses the inference engine 236 to make such decisions. The type of decision-making may depend upon the type of AI engine algorithm used. For example, AI engines trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, AI engines trained using unsupervised learning algorithms may be used to group (e.g., C_1, C_2 . . . . C_n 238) live data 334 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, AI engines that perform regression techniques may use live data 234 to predict or forecast continuous outcomes.

It will be understood that the embodiment of the AI subsystem 200 illustrated in FIG. 2 is exemplary and that other embodiments may vary. As another example, in some embodiments, the AI subsystem 200 may include more, fewer, or different components.

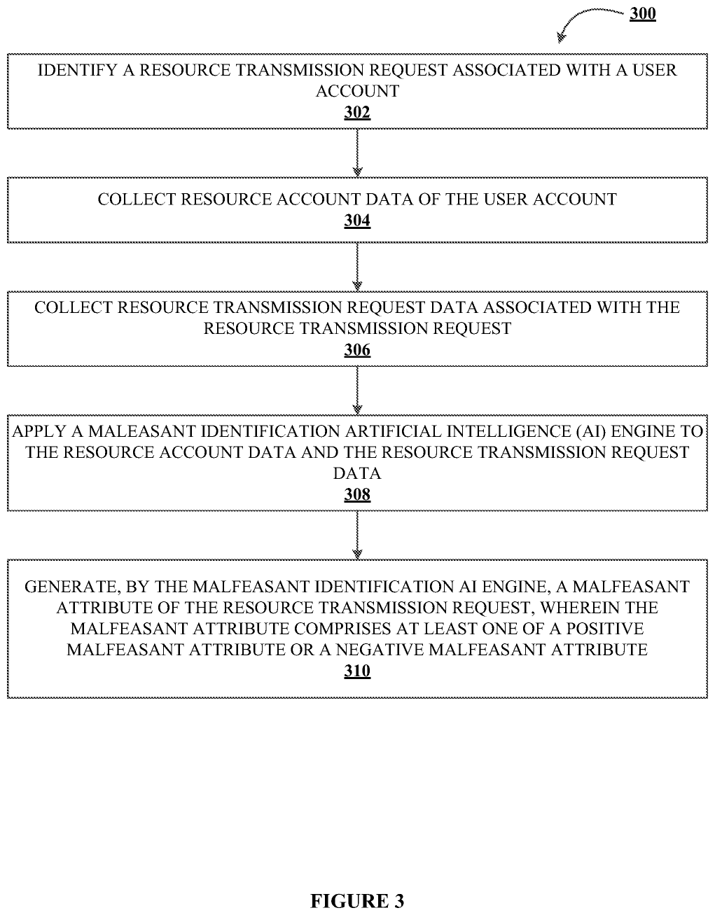

FIG. 3 illustrates a process flow 300 for threat indexing and implementing AI to detect malfeasant user activity in an electronic network, in accordance with an embodiment of the disclosure. In some embodiments, a system (e.g., similar to one or more of the systems described herein with respect to FIGS. 1A-1C and 2) may perform one or more of the steps of process flow 300. For example, a malfeasance identification system (e.g., the system 130 described herein with respect to FIG. 1A-1C and in combination with the AI engine subsystem 200 of FIG. 2) may perform the steps of process flow 300.

As shown in block 302, the process flow 300 may include the step of identifying a resource transmission request associated with a user account. In some embodiments, the malfeasance identification system may identify a resource transmission request based on a receipt of data of the resource transmission request from a user device, such as a user device associated with the user of the user account. For example, a resource transmission request may be generated at a user device and transmitted, via a network (such as network 110 of FIG. 1A), to the malfeasance identification system. In some embodiments, the malfeasance identification system may be housed, stored, and/or operated at a resource transmission processing center, whereby the resource transmission processing center may be configured to analyze resource transmission request and allow or deny the resource transmission requests.

In some embodiments, the resource transmission request comprises resource transmission request data that identifies a resource, an amount of resource, and/or the like. Further, and in some embodiments, the resource transmission request comprises a short-term resource advance request (e.g., such as a credit request), a long-term resource advance request (e.g., such as loan request), a resource transfer request (e.g., a resource transmission between two different resource accounts), and/or the like.

Additionally, and based on the resource transmission request, the malfeasance identification system may identify the user account and associated resource accounts of the user account, whereby such resource accounts may comprise the current resources held and/or owned by the user of the user account. Additionally, and in some embodiments, the resource accounts may comprise the user's current resource advance requests (e.g., current credit advancements, current loans, and/or the like). In some embodiments, the data of the user account (the resource account data) may additionally comprise previous resource data of the user such as a prior resource rating (e.g., a previous credit rating), previous resource holdings, previous resource advances, and/or the like.

As shown in block 304, the process flow 300 may include the step of collecting resource account data of the user account. In some embodiments, the malfeasance identification system may collect resource account data associated with the user account, which may comprise the current resource holdings/resources owned by the user of the user account, the current resource advances of the user account (e.g., the short-term resource advances, the long-term resource advances, and/or the like) or the like. As used herein, such resource account data may be collected from a client of the malfeasance identification system (e.g., a financial institution client of the malfeasance identification system), may be collected from a resource transmission processing center associated with the malfeasance identification system (e.g., a resource transmission processing center operated by an entity associated with the malfeasance identification system), from the malfeasance identification system itself (e.g., where the malfeasance identification system is operated within the resource transmission processing center), and/or the like. In some embodiments, the malfeasance identification system may be configured to collect all the resource account data associated with the user account, such that the malfeasance identification system may have a complete view of the user account's associated resources (including current resources owned, current resource advances, and/or the like).

As shown in block 306, the process flow 300 may include the step of collecting resource transmission request data associated with the resource transmission request. In some embodiments, the malfeasance identification system may collect the resource transmission request data based on the identified resource transmission request, whereby the resource transmission request data may comprise data regarding what kind of resource transmission is being requested, such as an identification of a request for a resource advance (such as a long-term resource advance request, a short-term resource advance request, and/or the like), an identification of a resource transmission (which may comprise an identification of a recipient user/recipient resource account), and/or the like. In some embodiments, and where the resource transmission request comprises a resource transmission and recipient resource account, the recipient resource account may comprise a resource account of the user that generated the resource transmission request, a different user than the user that generated the resource transmission request, and/or the like.

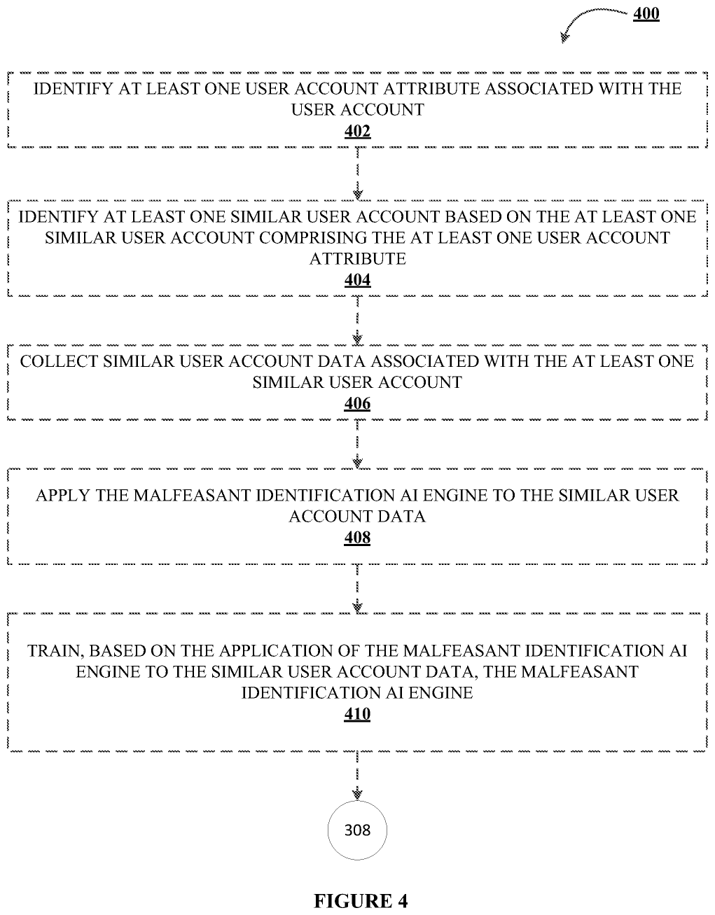

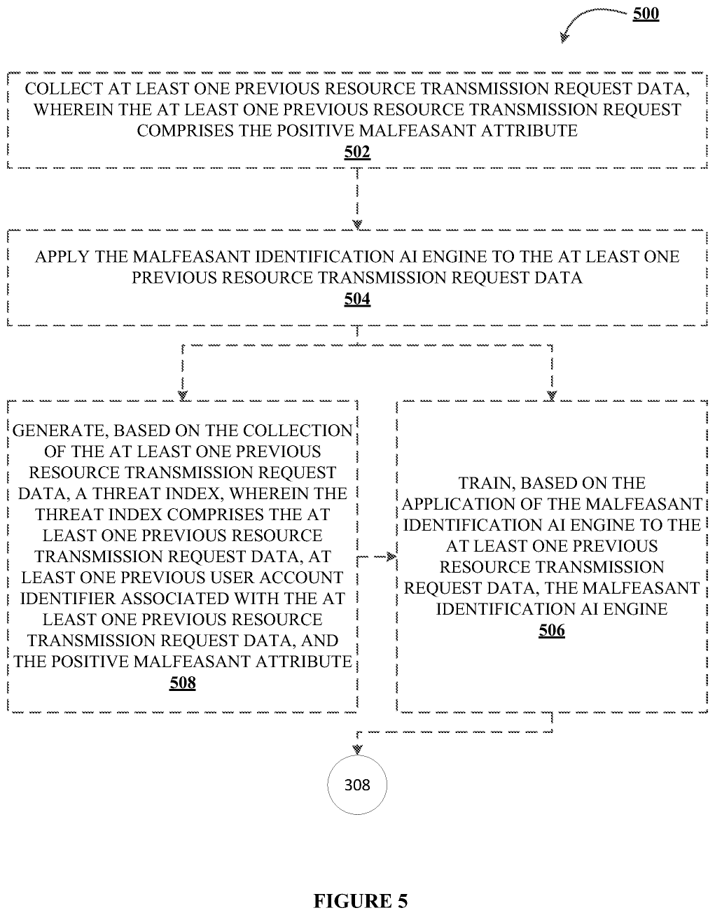

As shown in block 308, the process flow 300 may include the step of applying a malfeasant identification artificial intelligence (AI) engine to the resource account data and the resource transmission request data. In some embodiments, the malfeasance identification system may apply a malfeasant identification AI engine (which has been previously trained) to the data of the resource account and the resource transmission request to determine whether the resource transmission request comprises a malfeasant user activity and—based on this malfeasant user activity—a threat/malfeasant user activity. Such a threat/malfeasant user activity may refer to a threat to the user that generated the resource transmission request, a threat/malfeasant user activity to the entity associated with the resource transmission request (e.g., a financial institution), and/or the like. Further, and in some embodiments, the malfeasant user activity may be determined based on previous instances and/or previous user activities (previous resource transmission requests) of other user accounts. Such embodiments are discussed in further detail below with respect to FIGS. 4 and 5.

As shown in block 310, the process flow 300 may include the step of generating—by the malfeasant identification AI engine—a malfeasant attribute of the resource transmission request, wherein the malfeasant attribute comprises at least one of a positive malfeasant attribute or a negative malfeasant attribute. In some embodiments, the malfeasance identification system may determinevia the malfeasant identification AI engine-whether the resource transmission request comprises malfeasant user activity (i.e., a threat). Further, and in some embodiments, the malfeasant identification AI engine may generate a malfeasant attribute for the resource transmission request, whereby the malfeasant attribute may comprise a positive malfeasant attribute (indicating a threat is present and there is malfeasant user activity) or a negative malfeasant attribute (indicating a threat is likely not present and there is no malfeasant user activity). Additionally, and in some embodiments, the malfeasance identification system—after generating the malfeasant attribute—may attach and/or link the generated malfeasant attribute to the data of the user account (which may include the user account identifier), the data of the resource transmission request, and/or the like. Such data—the malfeasant attribute, user account identifier, resource transmission request—may be stored in a database, an index, and/or the like, such that the data is organized in an easily and efficiently accessible manner for the malfeasance identification system and its processing components. Such an index may comprise a threat index, which is described in further detail below with respect to FIG. 5.

FIG. 4 illustrates a process flow 400 for training the malfeasant identification AI engine using similar user account data, in accordance with an embodiment of the disclosure. In some embodiments, a system (e.g., similar to one or more of the systems described herein with respect to FIGS. 1A-1C and 2) may perform one or more of the steps of process flow 400. For example, a malfeasance identification system (e.g., the system 130 described herein with respect to FIG. 1A-1C and in combination with the AI engine subsystem 200 of FIG. 2) may perform the steps of process flow 400.

In some embodiments, and as shown in block 402, the process flow 400 may include the step of identifying at least one user account attribute associated with the user account. In some embodiments, the malfeasance identification system may identify at least one user account attribute associated with the user account that generated the resource transmission request, whereby such a user account attribute may comprise a high resource attribute (e.g., such that the malfeasance identification system will recognize the user account as likely being linked to a high resource individual-a user that allegedly owns a high amount of resources), a low resource attribute (e.g., such that the malfeasance identification system will recognize the user account as likely being linked to a low resource individual), a medium resource attribute (e.g., such that the malfeasance identification system will recognize the user account as likely being linked to a normal and/or medium resource individual—as compared to low or high resource individuals), and/or the like.

In some embodiments, and as shown in block 404, the process flow 400 may include the step of identifying at least one similar user account based on the at least one similar user account comprising the at least one user account attribute. By way of non-limiting example, the malfeasance identification system may identify at least one similar user account to the user account that generated the resource transmission request based on the at least one similar user account comprising the same user account attribute. For instance, the malfeasance identification system may compare the user account attribute of the user account that generated the resource transmission requests to the user account attributes of other user accounts to identify at least one similar user account(s) that comprises the same user account attribute(s).

Further, and in some embodiments, such data of the user account attributes for other user accounts may be stored and organized in a database, an index, and/or the like. For example, each index and/or database may comprise the data of the user accounts associated with a particular user account attribute, such that there is an index/database for each user account attribute which comprises a plurality of user account identifiers and user account data.

In some embodiments, and where the similar user account attribute of the similar user accounts comprises a negative malfeasant attribute and their associated data (e.g., previous resource transmission requests) do not indicate malfeasant user activity, the malfeasant identification AI engine may use this data to determine whether the current user account that generated the resource transmission request also comprises a negative malfeasant attribute. Similarly, and in some embodiments where the similar user account attribute of the similar user accounts comprises a positive malfeasant attribute and their associated data (e.g., previous resource transmission requests) indicates malfeasant user activity, the malfeasant identification AI engine may use this data to determine whether the current user account that generated the resource transmission request also comprises a positive malfeasant attribute.

By way of non-limiting example, and where the user account attribute comprises a high resource attribute, the malfeasance identification system-via the malfeasant identification AI engine—may use similar user accounts that also comprise high resource attributes to determine whether the user activity (e.g., the resource transmission request(s)) of the user account is acting in accordance or is acting as expected with the similar user accounts and their associated user activities. Similarly, the malfeasance identification system may additionally determine whether the user account that generated the resource transmission request is acting in accordance or is acting as expected as compared with similar user accounts comprising the same user account attribute and the similar user account activities. However, and in the embodiments, where the user account is not acting as expected as compared with similar user accounts, the malfeasance identification system-via the malfeasance identification AI engine—may generate the malfeasant attribute, such that a positive malfeasant attribute is generated where the user account comprises abnormal user activities and/or a negative malfeasant attribute is generated where the user account comprises normal user activities as compared to similar user accounts.

In some embodiments, and as shown in block 406, the process flow 400 may include the step of collecting similar user account data associated with the at least one similar user account. By way of non-limiting example, the malfeasance identification system may collect the data of the similar user account(s), whereby such data may comprise previous resource transmission requests, associated malfeasance attributes, and/or the like. In some embodiments, the data of the similar user account(s) may additionally comprise data of the similar users' such as a resource rating (e.g., a credit rating), current and/or previous resource holdings, current and/or previous resource advances, and/or the like.

In some embodiments, and as shown in block 408, the process flow 400 may include the step of applying the malfeasant identification AI engine to the similar user account data. By way of non-limiting example, the malfeasance identification system may apply the malfeasant identification AI engine to the similar user account data to generate and/or determine patterns in the data for future determination of current resource transmission requests for user accounts that are similar based on their user account attributes. Further, and in some embodiments, the malfeasance identification system may apply the malfeasant identification AI engine to the similar user account data, whereby the similar user account data comprises previous instances of resource transmission requests, previous resource account data (e.g., previous resource holdings, previous resource advances such as long-term and short-term, and/or the like), current resource account data (e.g., current resource holdings, current resource advances such as long-term and short-term, and/or the like), which may also be used to generate and/or determine patterns of what is expected and/or unexpected for future resource transmission requests and associated resource account data.

Additionally, and in some embodiments, such previous instances of similar user account data and associated resource transmission requests may additionally be used by the malfeasant identification AI engine to determine new user accounts and their associated resource transmission requests for what may be expected and/or unexpected. In this manner, the malfeasance identification system may determine malfeasant user activity even where no previous data for the user account that generated the resource transmission request is available (e.g., the user account with the entity that is a client of the malfeasance identification system may be new). For instance, a new user account may generate a resource transmission request, and the new user account may comprise a user account attribute (which may have been filled it by the client of the malfeasance identification system, the user of the user account, and/or the like, when setting up the new user account) and such a user account attribute may be used by the malfeasance identification system to assess whether the resource transmission request comprises expected user activity (is likely not malfeasant) and/or unexpected user activity (is likely malfeasant).

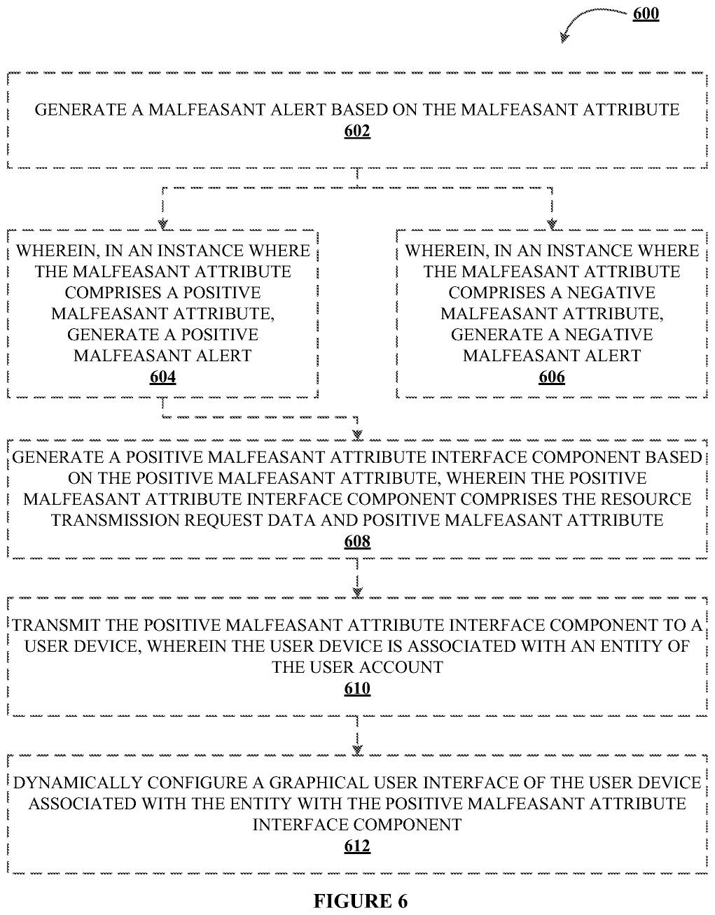

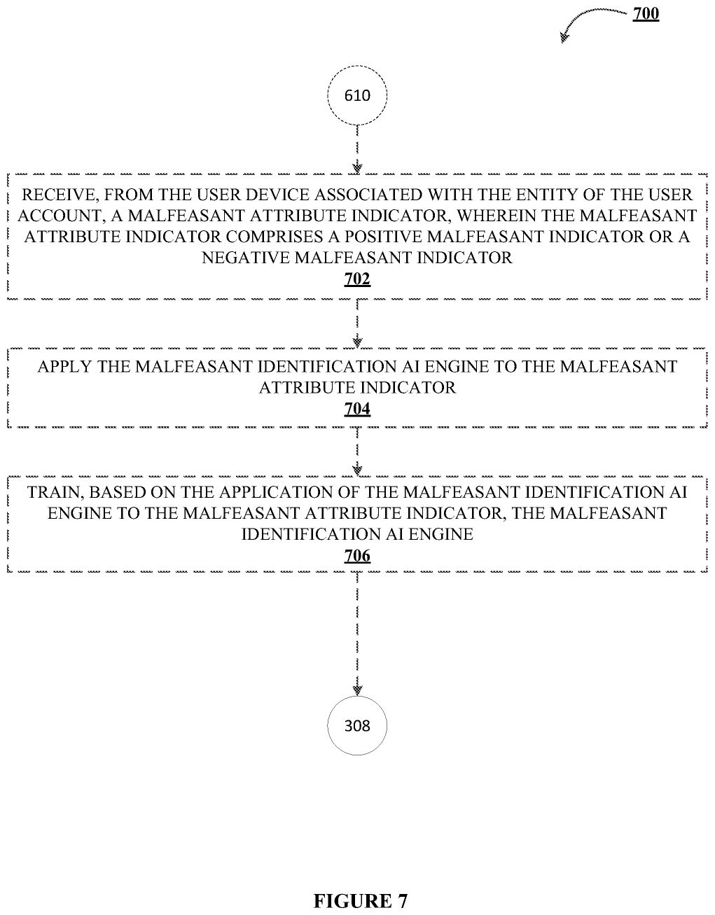

In some embodiments, and as shown in block 410, the process flow 400 may include the step of training, based on the application of the malfeasant identification AI engine to the similar user account data, the malfeasant identification AI engine. By way of non-limiting example, the malfeasant identification AI engine may be trained in whole and/or in part by applying the malfeasant identification AI engine to the similar user account data. In some embodiments, and as described in further detail here, the malfeasant identification AI engine may additionally be trained by the user account data of the user that generated the resource transmission request (as shown in FIG. 3), by data of previous resource transmission request data (as shown and described in FIG. 5), by feedback data after the malfeasant attribute has been generated (as shown and described in FIGS. 6 and 7), and/or the like.

Additionally, and in some embodiments, the processes described herein with respect to blocks 402-410 (both singularly and/or in combination) may be used before use of the malfeasant identification AI engine of block 308.

FIG. 5 illustrates a process flow 500 for generating a threat index, in accordance with an embodiment of the disclosure. In some embodiments, a system (e.g., similar to one or more of the systems described herein with respect to FIGS. 1A-1C and 2) may perform one or more of the steps of process flow 500. For example, a malfeasance identification system (e.g., the system 130 described herein with respect to FIG. 1A-1C and in combination with the AI engine subsystem 200 of FIG. 2) may perform the steps of process flow 500.

In some embodiments, and as shown in block 502, the process flow 500 may include the step of collecting at least one previous resource transmission request data, wherein the at least one previous resource transmission request comprises the positive malfeasant attribute. By way of non-limiting example, the malfeasance identification system may collect at least one previous resource transmission request data, whereby the at least one previous resource transmission request may be associated with at least one user account, a plurality of different user accounts, and/or the like. For example, the malfeasance identification system may be configured to access a database of previous resource transmission requests associated with the client of the malfeasance identification system (e.g., such as a financial institution using the malfeasance identification system to determine malfeasant user activities), an index of previous resource transmission requests (which is discussed in further detail below), and/or the like.

Further, and in some embodiments, the previous resource transmission requests may be associated with a plurality of user accounts and/or a singular user account, whereby the determination of which previous resource transmission requests to collect may be based on at least one of a time period (e.g., the most recent previous resource transmission requests), the data of the previous resource transmission request (e.g., collecting only those resource transmission requests that are associated with positive malfeasant attributes and/or negative malfeasant attributes), and/or only certain previous resource transmission requests that have been verified by the client of the malfeasance identification system (e.g., verified by a manager of the client, and/or the like), and/or the like. In such embodiments, the malfeasance identification system may determine which previous resource transmission requests to collect based on a breadth of the data available, the quality of the data available, and/or the like.

In some embodiments, and as shown in block 504, the process flow 500 may include the step of applying the malfeasant identification AI engine to the at least one previous resource transmission request data. By way of non-limiting example, the malfeasance identification system may apply the malfeasant identification AI engine to the at least one previous resource transmission request data in order to train the malfeasant identification AI engine to generate patterns and determine whether future resource transmission requests comprise malfeasant user activity. In this manner, the malfeasant identification AI engine may be trained—using the previous resource transmission request data collected (in whole or in part)—to determine which resource transmission requests likely comprise malfeasant user activity.

In some embodiments, and as shown in block 506, the process flow 500 may include the step of training, based on the application of the malfeasant identification AI engine to the at least one previous resource transmission request data, the malfeasant identification AI engine. By way of non-limiting example, the malfeasant identification AI engine may be trained to determine which resource transmission requests comprise malfeasant user activity and to generate malfeasant attributes based on this determination. For instance, the malfeasant identification AI engine may be trained to determine particular patterns and/or particular resource transmission request that likely comprise malfeasant user activities, and based on this training, may then determine whether future resource transmission requests comprise the same and/or similar malfeasant user activities.

In some embodiments, and as shown in block 508, the process flow 500 may include the step of generating-based on the collection of the at least one previous resource transmission request data-a threat index comprising the at least one previous resource transmission request data, at least one previous user account identifier associated with the at least one previous resource transmission request data, and the positive malfeasant attribute. By way of non-limiting example, the malfeasance identification system may generate-based on the collection of the previous resource transmission request data-a threat index, whereby the threat index may comprise each of the previous instances of the resource transmission requests and associated data, along with the associated malfeasant attributes, and associated user account identifiers that are associated with the user accounts that generated the previous resource transmission requests. Additionally, and in some embodiments, the threat index may comprise only the previous resource transmission request data that are associated with the positive malfeasant attributes. In this manner, the threat index may be used by the malfeasance identification system to specifically train the malfeasant identification AI engine to easily and quickly pick out the user activities that are positive for malfeasant user activities, rather than an entire database of all the previous resource transmissions that are associated with both positive malfeasant attributes and negative malfeasant attributes. In some embodiments, the threat index described herein may additionally comprise data regarding the user accounts of the user account identifiers, wherein such data may comprise the resource rating (e.g., credit rating of the user associated with the user account), previous and/or current resource holdings (e.g., resource account balances), previous and/or current resource advances, and/or the like.

Such an embodiment may improve processing speeds by allowing the malfeasant identification AI engine to easily and efficiently be trained using less data, may improve recall, and may improve storage capabilities of the malfeasance identification system, as a whole. Indeed, such an embodiment may improve processing speeds, decrease the computing resources needed to generate the threat index and to generate the malfeasant attributes generated by the malfeasant identification AI engine (e.g., see blocks 208-210).

In some embodiments, and in contrast, the malfeasance identification system may generate a plurality of indexes, such as a threat index and a non-threat index-whereby, such a non-threat index may comprise the previous resource transmission requests, associated user account identifiers, and associated malfeasant attributes comprising negative malfeasant attributes. In this manner, and similar to the technical improvements provided above, by training the malfeasant identification AI engine on such a non-threat index, the malfeasance identification system may comprise high processing speeds, improve recall time, and improve storage capabilities of the malfeasance identification system, as a whole.

In either embodiment and/or in both embodiments, the indexes described herein may be structured by the malfeasance identification system to comprise the data needed by the malfeasant identification AI engine to make determinations of malfeasant user activity and to generate malfeasant attributes for future resource transmission requests.

In some embodiments, the processes described herein with respect to blocks 502-508 (both singularly and/or in combination) may be used before use of the malfeasant identification AI engine of block 308.

FIG. 6 illustrates a process flow 600 for dynamically configuring a graphical user interface (GUI) of a user device with the positive malfeasant attribute interface component, in accordance with an embodiment of the disclosure. In some embodiments, a system (e.g., similar to one or more of the systems described herein with respect to FIGS. 1A-1C and 2) may perform one or more of the steps of process flow 600. For example, a malfeasance identification system (e.g., the system 130 described herein with respect to FIG. 1A-1C and in combination with the AI engine subsystem 200 of FIG. 2) may perform the steps of process flow 600.

In some embodiments, and as shown in block 602, the process flow 600 may include the step of generating a malfeasant alert based on the malfeasant attribute. By way of non-limiting example, the malfeasance identification system may generate a malfeasant alert based on the generation of the malfeasant attribute in block 310. Such an alert may be transmitted, as a data packet within a malfeasant attribute interface component, to a user device associated with an entity/client of the malfeasance identification system (e.g., such as a user device internal to the client's network like a manager and/or operator user device within a financial institution) over a network, such as network 110 of FIG. 1A. Thus, and in some embodiments, the malfeasance identification system may generate a malfeasant attribute interface component-based on the malfeasant alert-which may be used to configure the graphical use interface (GUI) of the user device associated with an entity/client of the malfeasance identification system, such that the configured GUI may show the manager and/or operator within the client/entity that a malfeasant user activity has occurred (or has not occurred, in some embodiments).

In some embodiments, and as shown in block 604, the process flow 600 may include the step of generating a positive malfeasant alert in an instance where the malfeasant attribute comprises a positive malfeasant attribute. By way of non-limiting example, the malfeasance identification system may generate a positive malfeasant alert when the malfeasant attribute for the resource transmission request is a positive malfeasant attribute. Such a positive malfeasant alert may be used by the malfeasance identification system to generate a positive malfeasant attribute interface component that comprises data to configure the GUI of the user device to indicate to the user that a positive malfeasant user activity has been determined.

In some embodiments, and as shown in block 606, the process flow 600 may include the step of generating a negative malfeasant alert in an instance where the malfeasant attribute comprises a negative malfeasant attribute. By way of non-limiting example, and where a negative malfeasant attribute is generated, the malfeasance identification system may be configured to generate a negative malfeasant alert. Similarly, the negative malfeasant alert may comprise data (such as within a malfeasant alert interface component) that configures the GUI of the user device to indicate to the user that no malfeasant user activity has been detected for the resource transmission request.

In some embodiments, and as shown in block 608, the process flow 600 may include the step of generating a positive malfeasant attribute interface component based on the positive malfeasant attribute, wherein the positive malfeasant attribute interface component comprises the resource transmission request data and positive malfeasant attribute. By way of non-limiting example, the malfeasance identification system may generate a positive malfeasant attribute interface component to configure the GUI of a user device to indicate whether malfeasant user activity is present. In some embodiments, the malfeasant attribute interface component may comprise data of the user account associated with the resource transmission request, data of the resource transmission request, the malfeasant alert, and/or the like.

In some embodiments, and as shown in block 610, the process flow 600 may include the step of transmitting the positive malfeasant attribute interface component to a user device, wherein the user device is associated with an entity of the user account. In some embodiments, the malfeasance identification system may transmit a negative malfeasant attribute interface component-based on the negative malfeasant alert—to the user device. By way of non-limiting example, the malfeasance identification system may—by transmitting the negative and/or positive malfeasant attribute interface component to the user device—update the GUI automatically and dynamically to show the user of the user device that the data of the resource transmission request. Such data of the resource transmission request may be generated in a human-readable format using the malfeasant attribute interface component (e.g., positive and/or negative) to show the user the information of the resource transmission request, the user account identifier of the resource transmission request, the reasoning for why the malfeasance attribute was positive or negative, and/or the like.

In some embodiments, and as shown in block 612, the process flow 600 may include the step of dynamically configuring a graphical user interface (GUI) of the user device associated with the entity with the positive malfeasant attribute interface component. By way of non-limiting example, the malfeasance identification system may—by transmitting the negative and/or positive malfeasant attribute interface component to the user device—update the GUI automatically and dynamically to show the user of the user device the resource transmission request data, the user account identifier, and/or the like.

In some embodiments, the configured GUI may additionally show the resource transmission request has been temporarily denied (where a positive malfeasant attribute is generated) or allowed (where a negative malfeasant attribute is generated). Thus, and in some embodiments, the malfeasance identification system may dynamically update the GUI of the user device once the malfeasant attribute is generated and the malfeasant attribute interface component is transmitted.

In some further embodiments, the malfeasance identification system may configure the GUI of the user device to accept user input of whether to continue to temporarily deny the resource transmission request, whether to allow the resource transmission request, whether to permanently block the resource transmission request, and/or the like. In some embodiments, such a user input may additionally be used by the malfeasance identification system to further train the malfeasant identification AI engine, which is described in further detail below with respect to FIG. 7.

FIG. 7 illustrates a process flow 700 for training the malfeasant identification AI engine using malfeasant attribute indicator, in accordance with an embodiment of the disclosure. In some embodiments, a system (e.g., similar to one or more of the systems described herein with respect to FIGS. 1A-1C and 2) may perform one or more of the steps of process flow 700. For example, a malfeasance identification system (e.g., the system 130 described herein with respect to FIG. 1A-1C and in combination with the AI engine subsystem 200 of FIG. 2) may perform the steps of process flow 700.

In some embodiments, and as shown in block 702, the process flow 700 may include the step of receiving—from the user device associated with the entity of the user account—a malfeasant attribute indicator, wherein the malfeasant attribute indicator comprises a positive malfeasant indicator or a negative malfeasant indicator. By way of non-limiting example, the malfeasance identification system may receive—from the user device—a malfeasant attribute indicator which may comprise data indicating whether the malfeasant attribute should be kept the same or changed. For instance, and where the originally generated malfeasant attribute (e.g., a positive malfeasant attribute) is generated by the malfeasant identification AI engine, the malfeasance identification system may receive a malfeasant attribute indicator from the user device comprising a positive malfeasant attribute indicator (e.g., the positive malfeasant attribute was correct) or a negative malfeasant attribute indicator (e.g., the positive malfeasant attribute was incorrect). In some embodiments, and where the malfeasant attribute was incorrect, the malfeasance identification system may be configured to change the malfeasant attribute for the resource transmission request. Further, and in the embodiments where the positive malfeasant attribute was incorrect and a negative malfeasant attribute indicator is received, the malfeasance identification system may change the malfeasance attribute and allow the resource transmission request in real time and automatically.

In some embodiments, and as shown in block 704, the process flow 700 may include the step of applying the malfeasant identification AI engine to the malfeasant attribute indicator. In some embodiments, and as shown in block 706, the process flow 700 may include the step of training-based on the application of the malfeasant identification AI engine to the malfeasant attribute indicator, the malfeasant identification AI engine. By way of non-limiting example, the malfeasance identification system may apply the malfeasant identification AI engine to the malfeasant attribute indicator to further train the malfeasant identification AI engine. In this manner, the malfeasant attribute indicator may be used as feedback for the malfeasant identification AI engine and may allow the malfeasant identification AI engine to correct its and/or change its patterns and decision-making.

As shown herein, the processes of FIG. 7 (i.e., blocks 702-706), either individually and/or in combination may follow the process described hereinabove with respect to block 612. Similarly, and as shown herein, the processes of FIG. 7 (i.e., blocks 702-706), either individually and/or in combination may precede the process described hereinabove with respect to block 308.

In some embodiments, the malfeasant identification AI engine may be trained on the singular datasets described herein (e.g., the similar user account data of FIG. 4; the index(es) and/or previous resource transmission request data of FIG. 5, the malfeasant attribute indicator of FIG. 7, and/or the like) and/or a combination of these datasets.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for threat indexing and implementing artificial intelligence (AI) to detect malfeasant user activity, the system comprising:
a memory device with computer-readable program code stored thereon;
at least one processing device operatively coupled to the at least one memory device and the at least one communication device, wherein executing the computer-readable code is configured to cause the at least one processing device to perform the following operations:
identify a resource transmission request associated with a user account;
collect resource account data of the user account;
collect resource transmission request data associated with the resource transmission request;
apply a malfeasant identification artificial intelligence (AI) engine to the resource account data and the resource transmission request data; and
generate, by the malfeasant identification AI engine, a malfeasant attribute of the resource transmission request, wherein the malfeasant attribute comprises at least one of a positive malfeasant attribute or a negative malfeasant attribute.

2. The system of claim 1, wherein the computer-readable code is configured to cause the at least one processing device to perform the following operations:
identify at least one user account attribute associated with the user account;
identify at least one similar user account based on the at least one similar user account comprising the at least one user account attribute;
collect similar user account data associated with the at least one similar user account;
apply the malfeasant identification AI engine to the similar user account data; and
train, based on the application of the malfeasant identification AI engine to the similar user account data, the malfeasant identification AI engine.

3. The system of claim 2, wherein the similar user account data is associated with a negative malfeasant attribute.

4. The system of claim 2, wherein the user account attribute comprises a high resource attribute.

5. The system of claim 1, wherein the computer-readable code is configured to cause the at least one processing device to perform the following operations:
collect at least one previous resource transmission request data, wherein the at least one previous resource transmission request data comprises the positive malfeasant attribute;
apply the malfeasant identification AI engine to the at least one previous resource transmission request data; and
train, based on the application of the malfeasant identification AI engine to the at least one previous resource transmission request data, the malfeasant identification AI engine.

6. The system of claim 5, wherein the computer-readable code is configured to cause the at least one processing device to perform the following operation:
generate, based on the collection of the at least one previous resource transmission request data, a threat index, wherein the threat index comprises the at least one previous resource transmission request data, at least one previous user account identifier associated with the at least one previous resource transmission request data, and the positive malfeasant attribute.

7. The system of claim 5, wherein the at least one previous resource transmission request data is associated with a plurality of user accounts.

8. The system of claim 1, wherein the computer-readable code is configured to cause the at least one processing device to perform the following operations:
generate a malfeasant alert based on the malfeasant attribute,
wherein, in an instance where the malfeasant attribute comprises a positive malfeasant attribute, generate a positive malfeasant alert, or
wherein, in an instance where the malfeasant attribute comprises a negative malfeasant attribute, generate a negative malfeasant alert.

9. The system of claim 8, wherein the computer-readable code is configured to cause the at least one processing device to perform the following operations:
generate a positive malfeasant attribute interface component based on the positive malfeasant attribute, wherein the positive malfeasant attribute interface component comprises the resource transmission request data and positive malfeasant attribute;
transmit the positive malfeasant attribute interface component to a user device, wherein the user device is associated with an entity of the user account; and
dynamically configure the graphical user interface of the user device associated with the entity with the positive malfeasant attribute interface component.

10. The system of claim 9, wherein the computer-readable code is configured to cause the at least one processing device to perform the following operations:
receive, from the user device associated with the entity of the user account, a malfeasant attribute indicator, wherein the malfeasant attribute indicator comprises a positive malfeasant indicator or a negative malfeasant indicator;
apply the malfeasant identification AI engine to the malfeasant attribute indicator; and
train, based on the application of the malfeasant identification AI engine to the malfeasant attribute indicator, the malfeasant identification AI engine.

11. A computer program product for threat indexing and implementing artificial intelligence (AI) to detect malfeasant user activity, wherein the computer program product comprises at least one non-transitory computer-readable medium having computer-readable program code portions embodied therein, the computer-readable program code portions which when executed by a processing device are configured to cause the processor to perform the following operations:
identify a resource transmission request associated with a user account;
collect resource account data of the user account;
collect resource transmission request data associated with the resource transmission request;
apply a malfeasant identification artificial intelligence (AI) engine to the resource account data and the resource transmission request data; and
generate, by the malfeasant identification AI engine, a malfeasant attribute of the resource transmission request, wherein the malfeasant attribute comprises at least one of a positive malfeasant attribute or a negative malfeasant attribute.

12. The computer program product of claim 11, wherein the processing device is configured to cause the processor to perform the following operations:
identify at least one user account attribute associated with the user account;
identify at least one similar user account based on the at least one similar user account comprising the at least one user account attribute;
collect similar user account data associated with the at least one similar user account;
apply the malfeasant identification AI engine to the similar user account data; and
train, based on the application of the malfeasant identification AI engine to the similar user account data, the malfeasant identification AI engine.

13. The computer program product of claim 11, wherein the processing device is configured to cause the processor to perform the following operations:
collect at least one previous resource transmission request data, wherein the at least one previous resource transmission request data comprises the positive malfeasant attribute;
apply the malfeasant identification AI engine to the at least one previous resource transmission request data; and
train, based on the application of the malfeasant identification AI engine to the at least one previous resource transmission request data, the malfeasant identification AI engine.

14. The computer program product of claim 13, wherein the processing device is configured to cause the processor to perform the following operation:
generate, based on the collection of the at least one previous resource transmission request data, a threat index, wherein the threat index comprises the at least one previous resource transmission request data, at least one previous user account identifier associated with the at least one previous resource transmission request data, and the positive malfeasant attribute.

15. The computer program product of claim 14, wherein the at least one previous resource transmission request data is associated with a plurality of user accounts.

16. A computer implemented method for threat indexing and implementing artificial intelligence (AI) to detect malfeasant user activity, the computer implemented method comprising:
identifying a resource transmission request associated with a user account;
collecting resource account data of the user account;
collecting resource transmission request data associated with the resource transmission request;
applying a malfeasant identification artificial intelligence (AI) engine to the resource account data and the resource transmission request data; and
generating, by the malfeasant identification AI engine, a malfeasant attribute of the resource transmission request, wherein the malfeasant attribute comprises at least one of a positive malfeasant attribute or a negative malfeasant attribute.

17. The computer implemented method of claim 16, further comprising:
identifying at least one user account attribute associated with the user account;
identifying at least one similar user account based on the at least one similar user account comprising the at least one user account attribute;
collecting similar user account data associated with the at least one similar user account;
applying the malfeasant identification AI engine to the similar user account data; and
training, based on the application of the malfeasant identification AI engine to the similar user account data, the malfeasant identification AI engine.

18. The computer implemented method of claim 16, further comprising:
collecting at least one previous resource transmission request data, wherein the at least one previous resource transmission request data comprises the positive malfeasant attribute;
applying the malfeasant identification AI engine to the at least one previous resource transmission request data; and
training, based on the application of the malfeasant identification AI engine to the at least one previous resource transmission request data, the malfeasant identification AI engine.

19. The computer implemented method of claim 18, further comprising:
generating based on the collection of the at least one previous resource transmission request data, a threat index, wherein the threat index comprises the at least one previous resource transmission request data, at least one previous user account identifier associated with the at least one previous resource transmission request data, and the positive malfeasant attribute.

20. The computer implemented method of claim 19, wherein the at least one previous resource transmission request data is associated with a plurality of user accounts.
